(19) United States
(12) Patent Application Publication
(10) Pub. No.: US 2025/0391844 A1
(43) Pub. Date: Dec. 25, 2025

(54) POSITIVE ELECTRODE ACTIVE MATERIAL, POSITIVE ELECTRODE PLATE, AND BATTERY

(71) Applicant: ZHUHAI COSMX BATTERY CO., LTD., Zhuhai (CN)

(72) Inventor: Gaolong KUANG, Zhuhai (CN)

(73) Assignee: ZHUHAI COSMX BATTERY CO., LTD., Zhuhai (CN)

(21) Appl. No.: 19/243,178

(22) Filed: Jun. 19, 2025

(30) Foreign Application Priority Data
Jun. 20, 2024 (CN) 202410803941.2

(51) Int. Cl. H01M 4/36; H01M 4/02; H01M 4/38; H01M 4/505; H01M 4/525

(52) U.S. Cl. CPC H01M 4/364; H01M 4/366; H01M 4/386; H01M 4/505; H01M 4/525; H01M 2004/021; H01M 2004/027; H01M 2004/028

(57) ABSTRACT

Disclosed are a positive electrode active material, a positive electrode plate and a battery including the positive electrode active material. The positive electrode active material includes a first particle and a second particle; the first particle includes a single crystal particle, the second particle includes a polycrystalline particle; the first particle includes element Al, the second particle includes element Al, and a weight content of element Al in the first particle Can and a weight content of element Al in the second particle C_{Al2} satisfy 0.4≤C_{Al2}/C_{Al1}≤4. The battery of the present disclosure can take into account energy density, cycling performance, high temperature performance, and furnace temperature safety performance.

### CROSS-REFERENCE TO RELATED APPLICATIONS

This application claims priority to Chinese Patent Application No. 202410803941.2, filed on Jun. 20, 2024, which is hereby incorporated by reference in its entirety.

### TECHNICAL FIELD

The present disclosure relates to the field of battery technologies, specifically to a positive electrode active material, a positive electrode plate and a battery including the positive electrode active material.

### BACKGROUND

Lithium nickel cobalt manganese ternary material is currently a commonly used positive electrode active material. To improve the energy density of lithium nickel cobalt manganese ternary material, the common method is to increase the content of nickel or enhance the practical application of cut-off voltage. However, increasing the content of nickel or enhancing the practical application of cut-off voltage will lead to a decrease in the cycling performance, high-temperature performance, and furnace temperature safety performance of the battery containing lithium nickel cobalt manganese ternary material.

Therefore, it is necessary to ensure that the battery containing lithium nickel cobalt manganese ternary material is capable of taking into account the energy density, cycling performance, high-temperature performance, and furnace temperature safety performance.

### SUMMARY

The purpose of the present disclosure is to overcome the problem in the conventional technology that the battery containing lithium nickel cobalt manganese ternary material cannot balance energy density, cycling performance, high-temperature performance, and furnace temperature safety performance, and to provide a positive electrode active material, a positive electrode plate and a battery including the positive electrode active material. The positive electrode active material of the present disclosure has high capacity and structural stability. The battery including the positive electrode active material of the present disclosure can balance energy density, cycling performance, high-temperature performance, and furnace temperature safety performance.

In related technologies, the lithium nickel cobalt manganese ternary material often leads to the deterioration of the battery's cycling performance, high-temperature performance, and furnace temperature safety performance when the content of nickel or the practical application of cut-off voltage is high. It was found that the reason for the above problem is that when the content of nickel increases, the increase of nickel, leads to an increase in the surface activity of the lithium nickel cobalt manganese ternary material, resulting in more side reactions occurring between the lithium nickel cobalt manganese ternary material and electrolyte solution, which affects the structural stability of the positive electrode active material and leads to a decrease in the cycling performance of the battery. Moreover, due to the increase in nickel, Ni²⁺ will occupy the position of Li+, deepening the degree of Li⁺/Ni²⁺ mixing and increasing residual lithium, leading to the deterioration of the bulk phase stability of the lithium nickel cobalt manganese ternary material, which in turn causes the cycling capacity of the battery to decay. In addition, under high-temperature conditions, the Li⁺/Ni²⁺ mixing will be further aggravated, leading to further deterioration of the bulk phase stability of lithium nickel cobalt manganese ternary material and further decay of the cycling capacity of the battery, and even leading to a fire or an explosion. Based on the above findings, the present disclosure proposes the following solution:

The first aspect of the present disclosure provides a positive electrode active material, which includes a first particle and a second particle; the first particle includes a substance with a chemical formula Liₐ₁Ni_{b1}CO_{c1}Mn_{d1}M¹ₑ₁O₂, where 0.8≤a1≤1.3, 0.8≤b1≤0.98, 0.02≤c1≤0.2, 0.01≤d1≤0.14, 0<e1≤0.08, M¹ includes at least one of Al, Zr, B, Y, Sr, W, Ti, Mg, or Nb, and M¹ at least includes Al; the first particle includes a single crystal particle; the second particle includes a substance with a chemical formula Liₐ₂Ni_{b2}CO_{c2}Mn_{d2}M²ₑ₂O₂, where 0.9≤a2≤1.3, 0.8≤b2≤0.98, 0.02≤c2≤0.3, 0.01≤d2≤0.12, 0<e2≤0.1, M² includes at least one of Al, Zr, B, Y, Sr, W, Ti, Mg, or Nb, and M² at least includes Al; the second particle includes a polycrystalline particle; the first particle includes element Al, and a weight content of the element Al in the first particle is C_{Al1}, the second particle include element Al, and a weight content of the element Al in the second particle is C_{Al2}, and Can and C_{Al2} satisfy 0.4≤C_{Al2}/C_{Al1}≤4.

The single crystal particle has excellent structural stability due to the uniformity of its internal crystal structure, consistent grain orientation, and the absence of grain boundaries; however, the large spacing between the single crystal particles increases the transmission distance of Li⁺, reduces the transmission efficiency of lithium ions, and makes the capacity performance and rate performance of the material worse. The polycrystalline particle is composed of several primary particles, and the grain boundaries inside the polycrystalline particle have a certain adverse effect on the structural stability of the material itself, and the risk of side reaction occurring between the primary particles and the electrolyte solution in the polycrystalline particle is greater, which further increases the possibility of structural collapse of the polycrystalline particle during the cycle; however, due to the small particle size of the primary particles in the polycrystalline particle, the transmission distance of Li⁺ is greatly shortened, which is conducive to the transmission of Li⁺, thus obtaining better capacity performance and rate performance. Mixing the polycrystalline particle and the single crystal particle can improve the cycling performance and rate performance to a certain extent, but the improvement effect is not satisfactory.

If both the single crystal particle and the polycrystalline particle include element Al, the structural stability of the positive electrode active material can be further improved, thereby enhancing the cycling performance and high-temperature performance of the battery. The reason is that the element Al can form an Al—O bond with a relatively high bond energy with the element O in the positive electrode active material, effectively inhibiting the escape of lattice oxygen; in addition, Al³⁺ is more stable in the tetrahedral environment, making it more difficult for cations to reconstruct into a spinel-like phase, thus reducing the kinetics of disordered spinel phase formation, inhibiting the phase transition of the positive electrode active material, so the element Al can play a role in stabilizing the bulk phase structure and has a certain inhibitory effect on Li⁺/Ni²⁺ mixing. Improved the cycling performance and high-temperature performance of the battery. Furthermore, when the ratio of the content of element Al in the single crystal particle to the content of element Al in the polycrystalline particle is within a specific range, it can further enhance the surface stability and structural stability of the bulk phase structure of the positive electrode active material. This is because the content of element Al has a certain influence on the morphological growth of both the single crystal particle and the polycrystalline particle.

However, too little Al cannot improve performance, while too much can lead to the following issues. Firstly, loss of material capacity: Al does not undergo valence change during cycling, and excessive Al can reduce the initial discharge capacity of the battery, affecting the energy density of the battery. Secondly, decrease in conductivity: excessive Al may disrupt the crystal structure of the material, affecting the transport paths of electrons and ions, thereby reducing the rate performance and charge-discharge efficiency of the battery. Thirdly, compatibility issues: excessive Al can promote the decomposition of the electrolyte solution, generating unstable interfacial phases, which can affect the cycling stability and safety of the battery.

A second aspect of the present disclosure provides a positive electrode plate, which includes the positive electrode active material described in the first aspect of the present disclosure.

A third aspect of the present disclosure provides a battery, which includes the positive electrode active material described in the first aspect of the present disclosure and/or the positive electrode plate described in the second aspect of the present disclosure.

Compared with the conventional technology, the present disclosure has the following beneficial effects.

Firstly, the positive electrode active material of the present disclosure has high capacity and structural stability.

Secondly, the battery of the present disclosure can balance energy density, cycling performance, high-temperature performance, and furnace temperature safety performance.

The endpoints of the ranges and any values disclosed in this specification are not limited to the precise ranges or values, and these ranges or values should be understood to include values close to these ranges or values. For numerical range, the endpoint values of each range, the endpoint values of each range and individual point values, as well as individual point values, can be combined to obtain one or more new numerical range, which should be considered as specifically disclosed in this specification.

### BRIEF DESCRIPTION OF THE DRAWINGS

FIG. 1 shows a Scanning Electron Microscope (SEM) image of a positive electrode plate in an example of the present disclosure.

### DETAILED DESCRIPTION OF THE EMBODIMENTS

The detailed descriptions of the embodiments of the present disclosure will be described in detail below. It should be understood that the specific embodiments described herein are only for illustrating and explaining the present disclosure, and are not intended to limit the present disclosure.

The first aspect of the present disclosure provides a positive electrode active material, which may include a first particle and a second particle. The first particle may include a substance with a chemical formula Liₐ₁Ni_{b1}Co_{c1}Mn_{d1}M¹ₑ₁O₂, where 0.8≤a1≤1.3 (for example, 0.8, 0.9, 1, 1.1, 1.2, or 1.3), 0.8≤b1≤0.98 (for example, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, or 0.98), 0.02≤c1≤0.2 (for example, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, or 0.2), 0.01≤d1≤0.14 (for example, 0.01, 0.02, 0.03, 0.04, 0.05, 0.06, 0.07, 0.08, 0.09, 0.1, 0.11, 0.12, 0.13, or 0.14), 0<e1≤0.08 (for example, 0.01, 0.02, 0.03, 0.04, 0.05, 0.06, 0.07, or 0.08), M¹ may include at least one of Al, Zr, B, Y, Sr, W, Ti, Mg, or Nb, and M¹ include at least Al. The second particle may include a substance with a chemical formula Liₐ₂Ni_{b2}Co_{c2}Mn_{d2}M²ₑ₂O₂, where 0.9≤a2≤1.3 (for example, 0.9, 1, 1.1, 1.2, or 1.3), 0.8≤b2≤0.98 (for example, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, or 0.98), 0.02≤c2≤0.3 (for example, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, or 0.3), 0.01≤d2≤0.12 (for example, 0.01, 0.02, 0.03, 0.04, 0.05, 0.06, 0.07, 0.08, 0.09, 0.1, 0.11, or 0.12), 0<e2≤0.1 (for example, 0.01, 0.02, 0.03, 0.04, 0.05, 0.06, 0.07, 0.08, 0.09, or 0.1), M² may include at least one of Al, Zr, B, Y, Sr, W, Ti, Mg, or Nb, and M² include at least Al.

The first particle may include a single crystal particle, and the second particle may include a polycrystalline particle. The first particle may include element Al, and the second particle may include element Al. A weight content of element Al in the first particle is C_{A11}, and a weight content of element Al in the second particle is C_{Al2}. C_{A11} and C_{Al2} satisfy 0.4≤C_{Al2}/C_{Al1≤4}, for example, 0.4, 0.5, 0.6, 0.7, 0.8, 0.9, 1, 1.5, 2, 2.5, 3, 3.5, or 4.

In one embodiment, 0.5≤C_{Al2}/C_{Al1}≤3.

In one embodiment, 1.2≤C_{Al2}/C_{Al1}≤1.3.

In the present disclosure, C_{Al1} may range from 500 ppm to 3000 ppm, for example, 500 ppm, 600 ppm, 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, or 3000 ppm.

In one embodiment, C_{Al2} ranges from 800 ppm to 2000 ppm.

In the present disclosure, C_{Al2} may range from 900 ppm to 3500 ppm, for example, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, or 3500 ppm.

In one embodiment, C_{Al2} ranges from 1000 ppm to 2400 ppm.

In the present disclosure, the weight content of the element Al in the first particle CAL and the weight content of the element Al in the second particle C_{Al2} can be obtained by conventional methods in the field, such as Inductively Coupled Plasma Optical Emission Spectrometry (ICP-OES) or Energy Dispersive Spectroscopy (EDS).

In the present disclosure, based on a total weight of the positive electrode active material, a content of the first particle is C1, 70%≤C1<100% (for example, 70%, 75%, 80%, 85%, 90%, 95%, or 99.9%).

In one embodiment, 73%≤C1≤93%.

By further controlling the weight content of the first particle in the positive electrode active material, it is beneficial to reduce the risk of side reactions between the positive electrode active material and electrolyte solution, and improve the cycling performance of the battery.

The element Zr can mitigate the oxygen charge loss of the positive electrode active material during deep charging, thereby stabilizing the lattice oxygen and improving the charge-discharge reversibility of the positive electrode active material; in addition, Zr⁴⁺ can increase the thermodynamic barrier for Ni²⁺ migration to the Li site, thereby inhibiting Li⁺/Ni²⁺ mixing. Therefore, when both the first particle and the second particle include the element Zr, it can improve the cycling performance, high-temperature performance, and furnace temperature safety performance of the battery. When the sum of the weight content of the element Zr in the first particle and the weight content of the element Zr in the second particle is within a specific range, it can further improve the cycling performance, high-temperature performance, and furnace temperature safety performance of the battery while ensuring the energy density of the battery.

In the present disclosure, the first particle may further include element Zr, the second particle may further include element Zr, a weight content of the element Zr in the first particle is C_{Zr1}, a weight content of the element Zr in the second particle is C_{Zr2}, and C_{Zr1} and C_{Zr2} satisfy 2500 ppm≤CZr1+C_{Zr2}≤8000 ppm, for example, 2500 ppm, 3000 ppm, 3500 ppm, 4000 ppm, 4500 ppm, 5000 ppm, 5500 ppm, 6000 ppm, 6500 ppm, 7000 ppm, 7500 ppm, or 8000 ppm.

In one embodiment, 3000 ppm≤CZr1+CZr2≤6800 ppm.

In one embodiment, 4600 ppm≤CZr1+CZr2≤5200 ppm.

In the present disclosure, C_{Zr1} may range from 1300 ppm to 3800 ppm, for example, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, 3500 ppm, 3600 ppm, 3700 ppm, or 3800 ppm.

In one embodiment, C_{Zr1} ranges from 1600 ppm to 3200 ppm.

In the present disclosure, C_{Zr2} may range from 1000 ppm to 4500 ppm, for example, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, 3500 ppm, 3600 ppm, 3700 ppm, 3800 ppm, 3900 ppm, 4000 ppm, 4100 ppm, 4200 ppm, 4300 ppm, 4400 ppm, or 4500 ppm.

In one embodiment, C_{Zr2} ranges from 1400 ppm to 3600 ppm.

In the present disclosure, the weight content of element Zr in the first particle C_{Zr1} and the weight content of element Zr in the second particle C_{Zr2} can be tested by conventional methods in the field, such as ICP-OES or EDS.

The elements Al and B have a good synergistic control effect on the crystal growth of the first particle. When the first particle includes both elements Al and B, it can make the surface of the first particle smoother, influence the nucleation and growth process of the first particle, regulate the size and distribution of the first particle, enabling the first particle to better embed into the gaps of the second particle, not only improving the structural stability of the positive electrode active material but also enhancing the press density of the positive electrode plate. When the sum of weight content of the elements Al and B in the first particle is within a specific range, it can further improve cycling performance and rate performance while maintaining a higher energy density in the battery.

In the present disclosure, the first particle may further include element B, and a weight content of element B in the first particle is C_{B1}. C_{A11} and C_{B1} satisfy 1000 ppm≤C_{A11}+C_{B1}≤6000 ppm, for example, 1000 ppm, 2000 ppm, 3000 ppm, 4000 ppm, 5000 ppm, or 6000 ppm.

In one embodiment, 1100 ppm≤C_{Al1}+C_{B1}≤3800 ppm.

In the present disclosure, C_{B1} may range from 100 ppm to 3000 ppm, for example, 100 ppm, 500 ppm, 1000 ppm, 1500 ppm, 2000 ppm, 2500 ppm, or 3000 ppm.

In one embodiment, C_{B1} ranges from 300 ppm to 1800 ppm.

In the present disclosure, the weight content of element B in the first particle C_{B1} can be tested by conventional methods in the field, such as ICP-OES or EDS.

In one embodiment, the first particle is the single crystal particle.

In one embodiment, the second particle is the polycrystalline particle. The second particle is composed of several primary particles. The term “several” refers to a number of the primary particles constituting the second particle is greater than or equal to 2.

In the present disclosure, an average particle size of the first particle D₁ may range from 0.5 μm to 4 μm, for example, 0.5 μm, 1 μm, 1.5 μm, 2 μm, 2.5 μm, 3 μm, 3.5 μm, or 4 μm.

In the present disclosure, an average particle size of the primary particle in the second particle D₂ may range from 100 nm to 900 nm, for example, 100 nm, 200 nm, 300 nm, 400 nm, 500 nm, 600 nm, 700 nm, 800 nm, or 900 nm.

In one embodiment, the average particle size of the primary particle in the second particle D₂ ranges from 100 nm to 500 nm.

In the present disclosure, an average particle size of the second particle D₃ may range from 6 μm to 18 μm, for example, 6 μm, 7 μm, 8 μm, 9 μm, 10 μm, 11 μm, 12 μm, 13 μm, 14 μm, 15 μm, 16 μm, 17 μm, or 18 μm.

In one embodiment, the average particle size of the second particle D₃ ranges from 7 μm to 15 μm.

In the present disclosure, the average particle size of the first particle D₁, the average particle size of the primary particle in the second particle D₂, and the average particle size of the second particle D₃ can be tested by conventional methods in the field, such as scanning electron microscopy (SEM). Specifically: taking a positive electrode plate, under the condition of 7.3 mm*10 kX magnification, testing the particle sizes of the first particles within the test field of view, and calculating the average value to obtain the average particle size of the first particle D₁; testing the particle size of the primary particles of the second particles within the test field of view, and calculating the average value to obtain the average particle size of the primary particles of the second particle D₂; testing the particle sizes of the second particles within the test field of view, and calculating the average value to obtain the average particle size of the second particle D₃.

It was found that when the ratio of the average particle size of the first particle D₁ to the average particle size of the second particle D₃ is within a specific range, it can make the overall active area of the positive electrode active material in contact with the electrolyte solution smaller and the press density higher, the main material and auxiliary material are combined more tightly, and the peeling force can be improved, thereby making the structural stability of positive electrode plate better, further improving cycling performance, high-temperature performance, and furnace temperature safety performance of the battery.

In the present disclosure, 0.01≤D₁/D₃≤0.5, for example, 0.01, 0.05, 0.1, 0.15, 0.2, 0.25, 0.3, 0.4, or 0.5.

In one embodiment, 0.07≤D₁/D₃≤0.3.

In the present disclosure, a median particle size of the first particle Dv¹₅₀ may range from 0.5 μm to 4 μm, for example, 0.5 μm, 1 μm, 1.5 μm, 2 μm, 2.5 μm, 3 μm, 3.5 μm, or 4 μm.

In the present disclosure, a median particle size of the second particle Dv¹₅₀ may range from 6 μm to 18 μm, for example, 6 μm, 7 μm, 8 μm, 9 μm, 10 μm, 11 μm, 12 μm, 13 μm, 14 μm, 15 μm, 16 μm, 17 μm, or 18 μm.

In the present disclosure, the median particle size of the first particle Dv¹₅₀ and the median particle size of the second particle Dv²₅₀ can be tested by conventional methods in the art, such as Laser Particle Size Analyzer.

In the present disclosure, 0.01≤Dv¹50/Dv²₅₀≤0.5, for example, 0.01, 0.05, 0.1, 0.15, 0.2, 0.25, 0.3, 0.4, or 0.5.

In the present disclosure, the first particle may be a layered structure material. The second particle may be a layered structure material.

The polycrystalline particle is formed by the agglomeration of several primary particles, thus significantly reducing the transmission distance of Li⁺, but the risk of side reactions occurring between the polycrystalline particle and the electrolyte solution is greater; whereas the single crystal particle do not produce a large number of uncoated fresh grain boundaries during the charge-discharge cycle process of the battery, effectively reducing the risk of side reactions occurring between the single crystal particle and the electrolyte solution, but larger particle size of the single crystal particle increases the transmission distance of Li+. The contents of nickel in the single crystal particle and the polycrystalline particle have significant impacts on their surface activity and crystal structure. When the content of nickel increases, it leads to an increase in the surface activity of both the single crystal particle and the polycrystalline particle, thereby increasing the risk of side reactions occurring between the single crystal particle and the polycrystalline particle with the electrolyte solution, respectively; and it also affects the transmission of Li⁺. Therefore, it is necessary to control the contents of nickel in the single crystal particle and the polycrystalline particle to better balance their respective advantages, thereby improving energy density, cycling performance, high-temperature performance, and furnace temperature safety performance of the battery.

In the present disclosure, the first particle may further include elements Ni, Co, and Mn. Based on a total molar number of elements Ni, Co, and Mn in the first particle, a molar number of element Ni is C_{Ni1}; the second particle may further include elements Ni, Co, and Mn. Based on a total molar number of elements Ni, Co, and Mn in the second particle, a molar number of element Ni is C_{Ni2}, and C_{Ni1}≥C_{Ni2}.

In one embodiment, C_{Ni1}>C_{Ni2}.

The structural stability of the first particle is better than that of the second particle. Therefore, to ensure that the positive electrode active material has a high nickel content and maintains good structural stability, it is necessary to regulate C_{Ni1} and C_{Ni2} so that C_{Ni1}≥ C_{Ni2}. When C_{Ni1}≥C_{Ni2}, the battery can balance energy density, cycling performance, high-temperature performance, and furnace temperature safety performance.

In the present disclosure, C_{Ni1} may range from 0.81 to 0.95, for example, 0.81, 0.82, 0.83, 0.84, 0.85, 0.86, 0.87, 0.88, 0.89, 0.90, 0.91, 0.92, 0.93, 0.94, or 0.95.

In the present disclosure, C_{Ni2} may range from 0.8 to 0.94, for example, 0.8, 0.81, 0.82, 0.83, 0.84, 0.85, 0.86, 0.87, 0.88, 0.89, 0.90, 0.91, 0.92, 0.93, or 0.94.

In the present disclosure, the molar number of element Ni in the first particle C_{Ni1} and the molar number of element Ni in the second particle C_{Ni2} can be tested by conventional methods in the art, such as ICP-OES or EDS.

In the present disclosure, the first particle may include a core and a shell on the outer surface of the core. The shell may include at least one of elements Al, Zr, B, Ti, or Nb.

It was found that when the first particle includes a shell and the shell includes specific elements, the battery's cycling performance, high-temperature performance, and furnace temperature safety performance can be further improved. The reason lies in that the shell can improve interface stability, increase ion mobility at the solid-liquid interface, and inhibit the occurrence of interface side reaction. Moreover, specific elements can form a fast ion/fast electron coating layer. When the thickness of the fast ion/fast electron coating layer is within a specific range, it can effectively reduce the surface impedance of the positive electrode active material, thereby reducing positive electrode plate resistivity.

In the present disclosure, a thickness of the shell may range from 3 nm to 25 nm, for example, 3 nm, 4 nm, 5 nm, 6 nm, 7 nm, 8 nm, 9 nm, 10 nm, 15 nm, 20 nm, or 25 nm.

In the present disclosure, a specific surface area of the first particle is BET₁, and a specific surface area of the second particle is BET₂. BET₁ and BET₂ satisfy: 1.2≤BET₁/BET₂≤4, for example, 1.2, 1.5, 2, 2.5, 3, 3.5, or 4.

In one embodiment, 1.6≤BET₁/BET₂≤1.8.

When BET₁/BET₂ is within a specific range, the electrolyte solution has a better wetting effect on the positive electrode active material, resulting in lower transmission impedance of lithium ions between the first particle and second particle, and simultaneously reducing the side reaction level caused by overheating when local impedance is too high.

In the present disclosure, 0.7 m²/g≤BET₁≤1.6 m²/g, for example, 0.7 m²/g, 0.8 m²/g, 0.9 m²/g, 1 m²/g, 1.1 m²/g, 1.2 m²/g, 1.3 m²/g, 1.4 m²/g, 1.5 m²/g, or 1.6 m²/g.

In one example, 0.7 m²/g≤BET₁≤1.4 m²/g.

In the present disclosure, 0.3 m²/g≤BET₂≤1.1 m²/g, for example, 0.3 m²/g, 0.4 m²/g, 0.5 m²/g, 0.6 m²/g, 0.7 m²/g, 0.8 m²/g, 0.9 m²/g, 1 m²/g, or 1.1 m²/g.

In one example, 0.4 m²/g≤BET₂≤0.85 m²/g.

In the present disclosure, the specific surface area of the first particle BET₁ and the specific surface area of the second particle BET₂ can be tested by conventional methods in the field, such as the Nitrogen Adsorption Method.

The present disclosure also provides a method for preparing the first particle, which can synthesize the first particle under low-temperature conditions, effectively solving the problems caused by higher synthesis temperatures.

In the present disclosure, the method for preparing the first particle may include the following steps.
(1) Mixing lithium source, nickel source, cobalt source, manganese source, and M¹ source uniformly.
(2) Heating the mixture obtained in step (1) in an oxygen atmosphere at a heating rate ranging from 2° C./min to 7° C./min (for example, 2° C./min, 3° C./min, 4° C./min, 5° C./min, 6° C./min, or 7° C./min) to a temperature ranging from 250° C. to 500° C. (for example, 250° C., 300° C., 350° C., 400° C., 450° C., or 500° C.), and maintaining the temperature for a time ranging from 2 h to 16 h (for example, 2 h, 3 h, 4 h, 5 h, 6 h, 7 h, 8 h, 9 h, 10 h, 11 h, 12 h, 13 h, 14 h, 15 h, or 16 h).

In the present disclosure, the lithium source may include LiOH·H₂O. The nickel source may include Ni(OH)₂. The cobalt source may include Co(OH)₂. The manganese source may include Mn(OH)₂. The M¹ source may include at least one of the oxide or hydroxide of element M¹.

In the present disclosure, M¹ may include at least one of Al, Zr, B, Y, Sr, W, Ti, or Nb, and M¹ includes at least Al.

In the present disclosure, a total molar amount of the nickel source calculated in terms of nickel, the cobalt source calculated in terms of cobalt, the manganese source calculated in terms of manganese, and the M¹ source calculated in terms of element M¹ is n, a molar amount of lithium source calculated in terms of lithium is n_{Li}, and n_{Li}:n can be (1-1.7): 1, for example, 1:1, 1.1:1, 1.2:1, 1.3:1, 1.4:1, 1.5:1, 1.6:1, or 1.7:1.

In the present disclosure, the method may further include adding an alkaline substance in step (1). The alkaline substance may include KOH and/or NaOH.

In the present disclosure, the method may further include, after step (2), cooling to room temperature, adding a shell material, heating to a temperature ranging from 300° C. to 400° C. (for example, 300° C., 350° C., or 400° C.), maintaining the temperature for a time ranging from 2 h to 5 h (for example, 2 h, 3 h, 4 h, or 5 h), and then crushing and sieving.

In the present disclosure, the shell material includes at least one of elements Al, Zr, B, Ti, or Nb.

In one embodiment, the shell material includes at least one of substances formed by the following elements with lithium: elements Al, Zr, B, Ti, or Nb.

In one embodiment, the shell material includes H₃BO₃ and/or ZrO₂.

The first particle prepared by this method has better structural stability, which can reduce the occurrence of micro-cracks that may occur during the charge-discharge process of the battery, and can also reduce the occurrence of Li⁺/Ni²⁺ mixing, thereby improving the cycling stability and cycle life of the battery.

The second aspect of the present disclosure provides a positive electrode plate, the positive electrode plate may include the positive electrode active material described in the first aspect of the present disclosure.

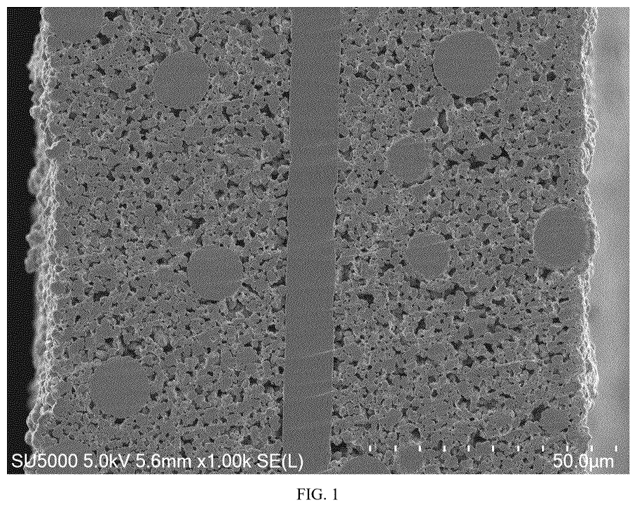

In the present disclosure, the positive electrode plate may include a positive electrode current collector and a positive electrode active material layer on at least one side surface of the positive electrode current collector. The positive electrode active material layer may include the positive electrode active material. As shown in FIG. 1, it is a Scanning Electron Microscope (SEM) image of a positive electrode plate according to an example of the present disclosure. It can be seen from the FIGURE that the positive electrode active material layer of the positive electrode plate includes the positive electrode active material, and the positive electrode active material includes the first particle and the second particle.

In the present disclosure, a press density of positive electrode plate is Q, in unit of g/cm³, a total weight content of the element Al and the element B in the first particle is C, in unit of ppm, and Q and C satisfy 160≤C/Q≤1700, for example, 160, 200, 300, 400, 500, 600, 700, 800, 900, 1000, 1100, 1200, 1300, 1400, 1500, 1600, or 1700. The relational expression only uses the numerical parts of C and Q for calculation, and the units are not involved in the calculation.

In one embodiment, 300≤C/Q≤1100.

It has been found that when Q and C satisfy a specific relationship, the probability of micro-cracks occurring in the positive electrode active material particle during the charge-discharge cycle process of the battery will be greatly reduced, and thus the surface side reaction will also be reduced, which can improve energy density while ensuring the battery's cycling performance, high-temperature performance, and furnace temperature safety performance of the battery.

In the present disclosure, Q may range from 3.3 to 3.6, in unit of g/cm³, for example, 3.3, 3.4, 3.5, or 3.6.

In the present disclosure, the positive electrode active material layer may further include a positive electrode conductive agent and a positive electrode binder. The positive electrode conductive agent may include the conductive agent conventionally used in the field, for example, at least one of conductive carbon black, acetylene black, Keqin black, conductive graphite, conductive carbon fiber, and carbon nanotube (including at least one of single-walled carbon nanotube and multi-walled carbon nanotube). The positive electrode binder may include the binder conventionally used in the field, such as at least one of polyvinylidene fluoride (PVDF), sodium carboxymethyl cellulose (CMC-Na), styrene-butadiene rubber (SBR), polytetrafluoroethylene (PTFE), and polyoxyethylene.

In the present disclosure, based on a total weight of the positive electrode active material layer, a content of the positive electrode active material may range from 80% to 99.8% (for example, 80%, 82%, 84%, 86%, 88%, 90%, 92%, 94%, 96%, 98%, 99%, or 99.8%), a content of the positive electrode conductive agent may range from 0.1% to 10% (for example, 10%, 9%, 8%, 7%, 6%, 5%, 4%, 3%, 2%, 1%, 0.5%, or 0.1%), and a content of the positive electrode binder may range from 0.1% to 10% (for example, 10%, 9%, 8%, 7%, 6%, 5%, 4%, 3%, 2%, 1%, 0.5%, or 0.1%).

The third aspect of the present disclosure provides a battery, which may include the positive electrode active material of the first aspect of the present disclosure and/or the positive electrode plate of the second aspect of the present disclosure.

In the present disclosure, the battery may further include a negative electrode plate. The negative electrode plate may include a negative electrode current collector and a negative electrode active material layer on at least one side surface of the negative electrode current collector. The negative electrode active material layer may include a silicon-based material.

In the present disclosure, the silicon-based material may include at least one of elemental silicon, silicon oxygen, silicon carbon, or silicon alloy. The silicon oxygen refers to a material including element silicon and element oxygen. The silicon carbon refers to a material including element silicon and element carbon.

In one embodiment, the silicon-based material includes silicon carbon. The silicon carbon includes a material formed by silicon distributed in a carbon skeleton.

In the present disclosure, a weight content of the silicon-based material in the negative electrode active material layer may range from 0.01% to 50%, for example, 0.01%, 0.05%, 0.1%, 0.5%, 1%, 5%, 10%, 15%, 20%, 25%, 30%, 35%, 40%, 45%, or 50%.

In one embodiment, the weight content of the silicon-based material in the negative electrode active material layer ranges from 18% to 25%.

The silicon-based material has a high specific capacity and is well compatible with the positive electrode active material described in the present disclosure. For example, it can increase the transmission efficiency of Li⁺ on the negative electrode side, regulate the CB (Cell Balance) value, and reduce the risk of lithium deposition. The positive electrode active material of the present disclosure has a low discharge temperature rise, has a good inhibitory effect on the volume expansion of the silicon-based material, and makes the battery have higher cycling performance and energy density.

In one embodiment, the battery is a lithium-ion secondary battery.

In the present disclosure, the battery may further include a separator. The positive electrode plate, the separator, and the negative electrode plate are wound.

In the present disclosure, the positive electrode plate may further include a positive tab, the negative electrode plate may further include a negative tab, and in the battery, a total number of the positive tab and the negative tab is greater than or equal to 2.

It has been found that when the total number of the positive tab and the negative tab is greater than or equal to 2, the energy density and high-temperature performance of the battery can be further improved. The reason is that the larger current-carrying area of tab is beneficial for increasing heat dissipation and improving electron transmission rate, which can effectively reduce the internal resistance of positive electrode plate/negative electrode plate, and the multi-tabs winding structure can reduce the heat concentration of tab, reduce the risk of thermal runaway of the battery under abnormal conditions such as overcharge and overdischarge, and improve the safety of the battery.

In one embodiment, the battery is a multi-tabs pouch battery.

In the present disclosure, the negative electrode active material layer may further include a carbon-based material, and the carbon-based material may include at least one of artificial graphite, natural graphite, mesocarbon microbead, soft carbon, or hard carbon.

In the present disclosure, the negative electrode active material layer may further include a negative electrode conductive agent and a negative electrode binder. The negative electrode conductive agent may include conductive agent conventionally used in the field, for example, at least one of conductive carbon black, acetylene black, Keqin black, conductive graphite, conductive carbon fiber, and carbon nanotube (including at least one of single-walled carbon nanotube and multi-wall carbon nanotube). The negative electrode binder may include the binder conventionally used in the field, for example, at least one of polyvinylidene fluoride (PVDF), sodium carboxymethyl cellulose (CMC-Na), styrene-butadiene rubber (SBR), polytetrafluoroethylene (PTFE), and polyoxyethylene.

In the present disclosure, based on a total weight of the negative electrode active material layer, a content of the negative electrode active material may range from 80% to 99.8% (for example, 80%, 82%, 84%, 86%, 88%, 90%, 92%, 94%, 96%, 98%, 99%, or 99.8%), a content of the negative electrode conductive agent may range from 0.1% to 10% (for example, 10%, 9%, 8%, 7%, 6%, 5%, 4%, 3%, 2%, 1%, 0.5%, or 0.1%), and a content of the negative electrode binder may range from 0.1% to 10% (for example, 10%, 9%, 8%, 7%, 6%, 5%, 4%, 3%, 2%, 1%, 0.5%, or 0.1%).

In the present disclosure, the battery may further include a separator and an electrolyte solution. The separator may include separator conventionally used in the field. The electrolyte solution may include the electrolyte solution conventionally used in the field.

It should be noted that in the present disclosure, the numerical expressions such as “first” and “second” are only used to distinguish different substances or usage methods and do not represent a difference in order.

The present disclosure will be described in detail below through examples. The examples described in the present disclosure is only a part of the examples of the present disclosure and not all of the examples. Based on the examples in the present disclosure, all other examples obtained by those of ordinary skill in the art without creative efforts fall within the scope of protection of the present disclosure.

In the following examples, unless otherwise specified, the materials used are all commercially available analytical grade.

The following examples are used to illustrate the battery of the present disclosure.

### Example 1

Preparing the battery according to the following method

### (1) Preparation of a First Particle

LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co, and Mn was calculated as 0.67a), then Al(OH)₃, Y₂O₃, and ZrO₂ were added, where a weight of Al(OH)₃ was 0.43% a, a weight of Y₂O₃ was 0.14% a, and a weight of ZrO₂ was 0.36% a. After mixing, the mixture was added to a crucible, the crucible was placed in a box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 0.72% a of H₃BO₃ was added, the mixture was heated to 350° C. and maintained for 5 h. After crushing and sieving, a first particle was obtained, where C_{A11} was 1400 ppm, C_{Zr1} was 2500 ppm, C_{B1} was 1200 ppm, C_{Al1}+C_{B1} was 2600 ppm, D₁ was 3 μm, Dv¹₅₀ was 3.1 μm, C_{Ni1} was 0.87, a thickness of a shell was 5.5 nm, and BET₁ was 1 m²/g.

### (2) Preparation of a Positive Electrode Plate

A positive electrode active material (the first particle and a second particle were mixed at a weight ratio of 80:20, where the second particle was commercially available, C_{Al2} was 1800 ppm, C_{Zr2} was 2500 ppm, D₂ was 300 nm, D₃ was 10 μm, Dv²₅₀ was 10.2 μm, C_{Ni2} was 0.85, and BET₂ was 0.6 m²/g), polyvinylidene fluoride, single-walled carbon nanotube, and multi-wall carbon nanotube were uniformly mixed at a weight ratio of 97.4:1.2:0.4:1, N-methylpyrrolidone (NMP) was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.4 g/cm³, C_{Al2}/C_{A11} was 1.29, C_{Zr1}+C_{Zr2} was 5000 ppm, D₁/D₃ was 0.3, C_{Ni}1>C_{Ni2}, BET₁/BET₂ was 1.67, and C/Q was 765.

### (3) Preparation of a Negative Electrode Plate

A negative electrode active material (artificial graphite and silicon carbon), single-walled carbon nanotube, multi-walled carbon nanotube, polyvinylidene fluoride, and sodium carboxymethyl cellulose were uniformly mixed at a weight ratio of 96.1:0.25:0.15:2.9:0.6 to obtain a mixture. And ethylene carbonate (EC) accounting for 1% of a total weight of the mixture was added, then added deionized water, and a negative electrode slurry (with a solid content of 45%) was obtained; the negative electrode slurry was uniformly applied onto a high-strength carbon-coated copper foil (with a thickness of 4 μm), after being baked, followed by rolling to obtain a negative electrode plate, where a weight content of the silicon carbon in the negative electrode active material layer was 20%.

### (4) Preparation of an Electrolyte Solution

In a glove box filled with inert gas (argon) (where H₂O<0.1 ppm, O2<0.1 ppm), ethylene carbonate, propylene carbonate, diethyl carbonate, and propyl propionate were uniformly mixed at a weight ratio of 15:10:10:65, then 1.25 mol/L of fully drying lithium hexafluorophosphate was quickly added into the mixture and stirred evenly, finally succinonitrile accounting for 0.5% of a total weight of the electrolyte solution was added, and after passing moisture content and free acid tests, the electrolyte solution was obtained.

### (5) Preparation of a Battery

The positive electrode plate prepared in step (2), the negative electrode plate prepared in step (3), and a separator (including a polyethylene substrate with a thickness of 5 μm, one side of the substrate was a ceramic layer with a thickness of 2 μm, and the other side was a polyvinylidene fluoride adhesive layer with a thickness of 1 μm) were wound by a winding machine to obtain a battery jelly roll isolated by the separator from the positive electrode plate and the negative electrode plate, then through the processes such as welding, packaging, electrolyte injection, forming, degassing, and sorting, to obtain a lithium battery, with a multi-tabs winding structure (a sum of the number of positive tabs and negative tabs were 44).

### Example 2

This example referred Example 1 for the process, the difference lied in step (1) and step (2), specifically as follows:

### (1) Preparation of a First Particle

LiOH·H₂O, Ni(OH)₂, Co(OH)₂, Mn(OH)₂, and NaOH were uniformly mixed at a molar ratio of 1.5:0.82:0.09:0.09:0.5 (a total weight of Li, Ni, Co, and Mn was calculated as 0.67a), then Al(OH)₃, Y₂O₃, and ZrO₂ were added, where a weight of Al(OH)₃ was 0.24% a, a weight of Y₂O₃ was 0.14% a, and a weight of ZrO₂ was 0.47% a. After mixing, the mixture was added to a crucible, the crucible was placed in a box-type muffle furnace (at oxygen atmosphere with a gas flow rate of 20 ml/min), the temperature was heated up to 450° C. at 5° C./min heating rate and maintained for 12 h, then it was naturally cooled to room temperature, After crushing, 0.18% a H₃BO₃ was added, the mixture was heated to 350° C. and maintained for 7 h. After crushing and sieving, a first particle was obtained, where C_{A11} was 800 ppm, C_{Zr1} was 3200 ppm, C_{B1} was 300 ppm, C_{A11}+C_{B1} was 1100 ppm, D₁ was 4 μm, Dv¹₅₀ was 4.1 μm, C_{Ni1} was 0.81, a thickness of a shell was 3.2 nm, and BET₁ was 0.7 m²/g.

### (2) Preparation of a Positive Electrode Plate

A positive electrode active material (the first particle and a second particle were mixed at a weight ratio of 73:27, where the second particle was commercially available, C_{Al2} was 1000 ppm, C_{Zr2} was 1400 ppm, D₂ was 100 nm, D₃ was 15 μm, Dv²₅₀ was 15.3 μm, C_{Ni2} was 0.8, and BET₂ was 0.4 m²/g), polyvinylidene fluoride, single-walled carbon nanotube, and multi-walled carbon nanotube were uniformly mixed at a weight ratio of 97.4:1.2:0.4:1, NMP was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.3 g/cm³, C_{Al2}/CANI was 1.25, C_{Zr1}+C_{Zr2} was 4600 ppm, D₁/D₃ was 0.27, C_{Ni1}>C_{Ni2}, BET₁/BET₂ was 1.75, and C/Q was 333.

### Example 3

This example referred to Example 1 for the process, the difference lied in step (1) and step (2), specifically as follows:

### (1) Preparation of a First Particle

LiOH·H₂O, Ni(OH)₂, Co(OH)₂, Mn(OH)₂, and NaOH were uniformly mixed at a molar ratio of 1.5:0.96:0.03:0.01:0.5 (a total weight of Li, Ni, Co, and Mn was calculated as 0.67a), then Al(OH)₃, Y₂O₃, and ZrO₂ were added, where a weight of Al(OH)₃ was 0.61% a, a weight of Y₂O₃ was 0.14% a, and a weight of ZrO₂ was 0.23% a. After mixing, the mixture was added to a crucible, the crucible was placed in a box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 1.08% a of H₃BO₃ was added, the mixture was heated to 350° C. and maintained for 4 h. After crushing and sieving, a first particle was obtained, where Can was 2000 ppm, C_{Zr1} was 1600 ppm, C_{B1} was 1800 ppm, C_{Al1}+C_{B1} was 3800 ppm, D₁ was 0.5 μm, Dv¹₅₀ was 0.5 μm, C_{Ni1} was 0.95, a thickness of a shell was 6.7 nm, and BET₁ was 1.4 m²/g.

### (2) Preparation of a Positive Electrode Plate

A positive electrode active material (the first particle and a second particle were mixed at a weight ratio of 93:7, where the second particle was commercially available, C_{Al2} was 2400 ppm, C_{Zr2} was 3600 ppm, D₂ was 500 nm, D₃ was 7 μm, Dv²₅₀ was 6.8 μm, C_{Ni2} was 0.94, and BET₂ was 0.85 m²/g), polyvinylidene fluoride, single-walled carbon nanotube, and multi-walled carbon nanotube were uniformly mixed at a weight ratio of 97.4:1.2:0.4:1, NMP was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.5 g/cm³, C_{Al2}/CAI was 1.2, C_{Zr1}+C_{Zr2} was 5200 ppm, D₁/D₃ was 0.07, C_{Ni}1>C_{Ni2}, BET₁/BET₂ was 1.65, and C/Q was 1086.

### Example Group 4

This Example group was used to verify the impact of change in “C_{Al2}/C_{A11}”.

This Example group referred to Example 2 or Example 3 for the process. The difference lied that the second particle, specifically as follows:
Example 4a, with reference to Example 2, specifically as follows: a positive electrode active material (the first particle and a second particle were mixed at a weight ratio of 73:27, where the second particle was commercially available, C_{Al2} was 2400 ppm, C_{Zr2} was 1400 ppm, D₂ was 100 nm, D₃ was 15 μm, Dv²₅₀ was 15.2 μm, C_{Ni2} was 0.8, and BET₂ was 0.4 m²/g), polyvinylidene fluoride, single-walled carbon nanotube and multiwall carbon nanotube were uniformly mixed at a weight ratio of 97.4:1.2:0.4:1, NMP was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.32 g/cm³, C_{Al2}/CANI was 3, and C/Q was 331;
Example 4b, with reference to Example 3, specifically as follows: a positive electrode active material (the first particle and a second particle were mixed at a weight ratio of 93:7, where the second particle was commercially available, C_{Al2} was 1000 ppm, C_{Zr2} was 3600 ppm, D₂ was 500 nm, D₃ was 7 μm, Dv²₅₀ was 7.2 μm, C_{Ni2} was 0.94, and BET₂ was 0.85 m²/g), polyvinylidene fluoride, single-walled carbon nanotube and multiwall carbon nanotube were uniformly mixed at a weight ratio of 97.4:1.2:0.4:1, NMP was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.4 g/cm³, C_{Al2}/CALI was 0.5, and C/Q was 1118.

### Example Group 5

This Example group was used to verify the impact of the change in “C_{Al1}”.

This Example group referred to Example 1 for the process. The difference lied in the first particle, specifically as follows:
Example 5a, LiOH·H₂O, Ni(OH)₂, Co(OH)₂, Mn(OH)₂ and NaOH were uniformly mixed at a molar ratio of 1.5:0.88:0.06:0.06:0.5 (a total weight of Li, Ni, Co and Mn was calculated as 0.67a), then Al(OH)₃, Y₂O₃, and ZrO₂ were added, where a weight of Al(OH)₃ was 0.15% a, a weight of Y₂O₃ was 0.14% a, and a weight of ZrO₂ was 0.36% a. After mixing, the mixture was added to a crucible, the crucible was placed in a box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 0.72% a of H₃BO₃ was added, the mixture was heated to 350° C. and maintained for 5 h. After crushing and sieving, a first particle was obtained, where Can was 500 ppm, C_{Zr1} was 2500 ppm, C_{B1} was 1200 ppm, C_{Al1}+C_{B1} was 1700 ppm, D₁ was 3 μm, Dv¹₅₀ was 2.9 μm, C_{Ni1} was 0.87, a thickness of a shell was 5.4 nm, BET₁ was 1 m²/g, a press density Q of the positive electrode plate was 3.36 g/cm³, C_{Al2}/CALI was 3.6, and C/Q was 506;
Example 5b, LiOH·H₂O, Ni(OH)₂, Co(OH)₂, Mn(OH)₂ and NaOH were uniformly mixed at a molar ratio of 1.5:0.88:0.06:0.06:0.5 (a total weight of Li, Ni, Co and Mn was 0.67a), then Al(OH)₃, Y₂O₃, and ZrO₂ were added, where a weight of Al(OH)₃ was 0.91% a, a weight of Y₂O₃ was 0.14% a, and a weight of ZrO₂ was 0.36% a. After mixing, the mixture was added to a crucible, the crucible was placed in a box-type muffle furnace (at oxygen atmosphere with a gas flow rate of 20 ml/min), the temperature was heat ed up to 450° C. at a heating rate of 5° C./min and maintained for 12 h, then it was naturally cooled to room temperature. After crushing, 0.72% a of H₃BO₃ was added, the mixture was heated to 350° C. and maintained for 5 h. After crushing and sieving a first particle was obtained, where C_{A11} was 3000 ppm, C_{Zr1} was 2500 ppm, C_{B1} was 1200 ppm, C_{Al1}+C_{B1} was 4200 ppm, D₁ was 3 μm, Dv¹₅₀ was 3.2 μm, Cil was 0.87, a thickness of the shell was 5.5 nm, BET₁ was 1 m²/g, a press density Q of the positive electrode plate was 3.38 g/cm³, C_{Al2}/C_{A11} was 0.6, and C/Q was 1243.

### Example Group 6

This Example group was used to verify the impact of the change in “C_{Zr1}”.

This Example group referred to Example 1 for the process. The difference was that the first particle, specifically as follows:
Example 6a, LiOH·H₂O, Ni(OH)₂, Co(OH)₂, Mn(OH)₂ and NaOH were uniformly mixed at a molar ratio of 1.5:0.88:0.06:0.06:0.5 (a total weight of Li, Ni, Co and Mn was calculated as 0.67a), then Al(OH)₃, Y₂O₃, and ZrO₂ were added, where a weight of Al(OH)₃ was 0.43% a, a weight of Y₂O₃ was 0.14% a, and a weight of ZrO₂ was 0.72% a. After mixing, the mixture was added to a crucible, the crucible was placed in the box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 0.72% a of H₃BO₃ was added, the mixture was heated to 350° C. and maintained for 7 h. After crushing and sieving, a first particle was obtained, where C_{A11} was 1400 ppm, Czrl was 1300 ppm, C_{B1} was 1200 ppm, C_{Al1}+C_{B1} was 2600 ppm, D₁ was 3 μm, Dv¹₅₀ was 3.2 μm, C_{Ni1} was 0.87, a thickness of a shell was 5.6 nm, BET₁ was 1 m²/g, and C_{Zr1}+C_{Zr2} was 3800 ppm;
Example 6b, Ni(OH)₂, Co(OH)₂, Mn(OH)₂ and NaOH were uniformly mixed at a molar ratio of 1.5:0.88:0.06:0.06:0.5 (a total weight of Li, Ni, Co and Mn was calculated as 0.67a), then Al(OH)₃, Y₂O₃, and ZrO₂, were added where a weight of Al(OH)₃ was 0.43% a, a weight of Y₂O₃ was 0.14% a, and a weight of ZrO₂ was 0.55% a. After mixing, the mixture was added to a crucible, the crucible was placed in the box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 0.72% a of H₃BO₃ was added, the mixture was heated to 350° C. and maintained for 7 h. After crushing and sieving, a first particle was obtained, where C_{A11} was 1400 ppm, C_{Zr1} was 3800 ppm, C_{B1} was 1200 ppm, C_{Al1}+C_{B1} was 2600 ppm, D₁ was 3 μm, Dv¹₅₀ was 3.1 μm, C_{Ni1} was 0.87, a thickness of a shell was 5.4 nm, BET₁ was 1 m²/g, and C_{Zr1}+C_{Zr2} was 6300 ppm.

### Example Group 7

This Example group was used to verify the impact of the change in “C_{B1}”.

This Example group referred to Example 1 for the process. The difference lied in the first particle, specifically as follows:
Example 7a, LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co and Mn was calculated as 0.67a), then Al(OH)₃, Y₂O₃, and ZrO₂ were added, where a weight of Al(OH)₃ was 0.43% a, a weight of Y₂O₃ was 0.14% a, and a weight of ZrO₂ was 0.36% a. After mixing, the mixture was added to a crucible, the crucible was placed in the box-type muffle furnace (at oxygen atmosphere with a gas flow rate of 20 ml/min), the temperature was heated up to 450° C. at a heating rate of 5° C./min and maintained for 12 h, then it was naturally cooled to room temperature, After crushing, 0.06% a of H₃BO₃ was added, the mixture was heated to 350° C. and maintained for 5 h. After crushing and sieving, a first particle was obtained, where Can was 1400 ppm, C_{Zr1} was 2500 ppm, C_{B1} was 100 ppm, C_{Al1}+C_{B1} was 1500 ppm, D₁ was 3 μm, Dv¹₅₀ was 3 μm, C_{Ni1} was 0.87, a thickness of a shell was 2.6 nm., BET₁ was 1 m²/g, and C/Q was 441;
Example 7b, LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co and Mn was calculated as 0.67a), then Al(OH)₃, Y₂O₃, and ZrO₂ were added, where a weight of Al(OH)₃ was 0.43% a, a weight of Y₂O₃ was 0.14% a, and a weight of ZrO₂ was 0.36% a. After mixing, the mixture was added to a crucible, the crucible was placed in the box-type muffle furnace (at oxygen atmosphere with a gas flow rate of 20 ml/min), the temperature was heated up to 450° C. at a heating rate of 5° C./min and maintained for 12 h, then it was naturally cooled to room temperature, After crushing, 1.8% a of H₃BO₃ was added, the mixture was heated to 350° C. and maintained for 7 h. After crushing and sieving, a first particle was obtained, where Can was 1400 ppm, C_{Zr1} was 2500 ppm, C_{B1} was 3000 ppm, C_{Al1}+C_{B1} was 4400 ppm, D₁ was 3 μm, Dv¹₅₀ was 3.1 μm, C_{Ni1} was 0.87, a thickness of a shell was 7.2 nm, BET₁ was 1 m2/g, and C/Q was 1294.

### Example Group 8

This Example group was used to verify the impact of change in “C_{Ni1}>C_{Ni2}”.

This Example group referred to Example 1 for the process. The difference lied in the second particle, specifically as follows:
Example 8a, a second particle was commercially obtained, C_{Al2} was 1800 ppm, C_{Zr2} was 2500 ppm, D₂ was 300 nm, D₃ was 10 μm, Dv²₅₀ was 10.1 μm, C_{Ni2} was 0.87, BET₂ was 0.6 m²/g, and C_{Ni1}=C_{Ni2};
Example 8b, a second particle was commercially obtained, C_{Al2} was 2400 ppm, C_{Zr2} was 3600 ppm, D₂ was 500 nm, D₃ was 7 μm, Dv²₅₀ was 7.1 μm, C_{Ni2} was 0.94, BET₂ was 0.85 m²/g, C_{Ni}1<C_{Ni2}, C_{Zr1}+C_{Zr2} was 6100 ppm, D₁/D₃ was 0.43, BET₁/BET₂ was 1.18, Q was 3.43 g/cm³, and C/Q was 758.

### Example 9

This example was used to verify the impact of change in “shell of the first particle”.

This example referred to Example 1 for the process. The difference lied in the first particle, specifically as follows:
LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co, and Mn was calculated as 0.67a), then Al(OH)₃, Y₂O₃, and ZrO₂ were added, where a weight of Al(OH)₃ was 0.43% a, a weight of Y₂O₃ was 0.14% a, and a weight of ZrO₂ was 0.36% a. After mixing, the mixture was added to a crucible, the crucible was placed in a box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing and sieving, a first particle was obtained, where C_{A11} was 1400 ppm, C_{Zr1} was 2500 ppm, C_{B1} was 0 ppm, C_{A11}+C_{B1} was 1400 ppm, D₁ was 3 μm, Dv¹₅₀ was 2.9 μm, C_{Ni1} was 0.87, no shell, BET₁ was 1.1 m²/g, BET₁/BET₂ was 1.83, Q was 3.39 g/cm³, and C/Q was 413.

### Example Group 10

This Example group was used to verify the impact of change in “the weight content of the first particle in the positive electrode active material”.

This Example group referred to Example 1, with the difference lied in the change in the weight ratio of the first and second particle in the positive electrode active material, specifically as follows:
Example 10a, a weight ratio of the first particle to the second particle was 70:30, where Q was 3.45 g/cm³, and C/Q was 754;
Example 10b, a weight ratio of the first particle to the second particle was 98:2, where Q was 3.33 g/cm³, and C/Q was 781.

### Example Group 11

This Example group was used to verify the impact of change in “C_{Al2}”.

This Example group referred to Example 1 for the process. The difference lied in the second particle, specifically as follows:
Example 11a, a second particle was commercially obtained, C_{Al2} was 900 ppm, C_{Zr2} was 2500 ppm, D₂ was 300 nm, D₃ was 10 μm, Dv²₅₀ was 10.2 μm, C_{Ni2} was 0.85, BET₂ was 0.6 m2/g, and CAD/CAMI was 0.64;
Example 11b, a second particle was commercially obtained, C_{Al2} was 3500 ppm, C_{Zr2} was 2500 ppm, D₂ was 300 nm, D₃ was 10 μm, Dv²₅₀ was 10 μm, C_{Ni2} was 0.85, BET₂ was 0.6 m²/g, and C_{Al2}/C_{A11} was 2.5.

### Example Group 12

This Example group was used to verify the impact of change in “C_{Zr2}”.

This Example group referred to Example 1 for the process. The difference lied in the second particle, specifically as follows:
Example 12a, a second particle was commercially obtained, C_{Al2} was 1800 ppm, C_{Zr2} was 1000 ppm, D₂ was 300 nm, D₃ was 10 μm, Dv²₅₀ was 10.1 μm, C_{Ni2} was 0.85, BET₂ was 0.6 m²/g, and C_{Zr1}+C_{Zr2} was 3500 ppm;
Example 12b, a second particle was commercially obtained, C_{Al2} was 1800 ppm, C_{Zr2} was 4500 ppm, D₂ was 300 nm, D₃ was 10 μm, Dv²₅₀ was 10.1 μm, C_{Ni2} was 0.85, BET₂ was 0.6 m²/g, and C_{Zr1}+C_{Zr2} was 7000 ppm.

### Example Group 13

This Example group was used to verify the impact of change in “D₂”.

This Example group referred to Example 1 for the process. The difference lied in the average particle size of the second particle, specifically as follows:
Example 13a, D₂ was 700 nm, D₃ was 16 μm, Dv²₅₀ was 16.1 μm, BET₂ was 0.35 m²/g, D₁/D₃ was 0.188, BET₁/BET₂ was 2.86, Q was 3.52 g/cm³, and C/Q was 739;
Example 13b, D₂ was 900 nm, D₃ was 18 μm, Dv²₅₀ was 18.2 μm, BET₂ was 0.32 m²/g, D₁/D₃ was 0.17, BET₁/BET₂ was 3.13, Q was 3.52 g/cm³, and C/Q was 739.

### Example Group 14

This Example group was used to verify the impact of change in “C_{Zr1}+C_{Zr2}”.

This Example group referred to Example 2 or Example 3 for the process. The difference lied in the second particle, specifically as follows:
Example 14a, referenced to Example 2, a second particle was commercially obtained, C_{Al2} was 1000 ppm, C_{Zr2} was 3600 ppm, D₂ was 100 nm, D₃ was 15 μm, Dv²₅₀ was 15.2 μm, C_{Ni2} was 0.8, BET₂ was 0.4 m²/g, and C_{Zr1}+C_{Zr2} was 6800 ppm;
Example 14b, referenced to Example 3, a second particle was commercially obtained, C_{Al2} was 2400 ppm, C_{Zr2} was 1400 ppm, D₂ was 500 nm, D₃ was 7 μm, Dv²₅₀ was 7 μm, C_{Ni2} was 0.94, BET₂ was 0.85 m²/g, C_{Zr1}+C_{Zr2} was 3000 ppm, Q was 3.4 g/cm³, and C/Q was 1118.

### Example Group 15

This Example group was used to verify the impact of change in “a weight content of the silicon-based material in the negative electrode active material layer”.

This Example group referred to Example 1 for the process. The difference lied in the weight content of the silicon carbon in the negative electrode active material, specifically as follows:
Example 15a, a weight content of the silicon carbon in the negative electrode active material layer was 5%;
Example 15b, a weight content of the silicon carbon in the negative electrode active material layer was 18%;
Example 15c, a weight content of the silicon carbon in the negative electrode active material layer was 25%;
Example 15d, a weight content of the silicon carbon in the negative electrode active material layer was 40%.

### Example 16

This Example was used to verify the impact of change in “a sum of the number of the positive tabs and negative tabs”.

This Example referred to Example 1 for the process. The difference lied in a sum of the number of the positive tab and negative tab was 2.

### Example 17

This example was used to verify the impact of change in “preparation method of the first particle”.

This example referred to Example 1 for the process, the difference lied in the preparation of the first particle in step (1) was changed as follows: LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co, and Mn was calculated as 0.67a), then Al(OH)₃, Y₂O₃, and ZrO₂ were added, where a weight of Al(OH)₃ was 0.32% a, a weight of Y₂O₃ was 0.14% a, and a weight of ZrO₂ was 0.34% a. After mixing, the mixture was added to a crucible, the crucible was placed in a box-type muffle furnace (at oxygen atmosphere with a gas flow rate of 20 ml/min), the temperature was heated up to 850° C. at a heating rate of 5° C./min and maintained for 20 h, then it was naturally cooled to room temperature. After crushing, 0.7% a of H₃BO₃ was added, the mixture was heated to 600° C. and maintained for 5 h. After crushing and sieving, a first particle was obtained, where CANI was 1400 ppm, C_{Zr1} was 2500 ppm, C_{B1} was 1200 ppm, C_{Al1}+C_{B1} was 2600 ppm, D₁ was 3 μm, Dv¹₅₀ was 3.2 μm, C_{Ni1} was 0.87, a thickness of a shell was 5.4 nm, and BET₁ was 1 m²/g.

All the above examples meet: a chemical formula of the first particle was Liₐ₁Ni_{b1}Co_{c1}Mn_{d1}M¹ₑ₁O₂, where 0.8≤a1≤1.3, 0.8≤b1≤0.98, 0.02≤c1≤0.2, 0.01≤d1≤0.14, 0<e1≤0.08, M¹ includes at least one of Al, Zr, B, Y, Sr, W, Ti, or Nb, and M¹ at least includes Al. A chemical formula of the second particle was Liₐ₂Ni_{b2}CO_{c2}Mn_{d2}M²ₑ₂O₂, where 0.9≤a2≤1.3, 0.8≤b2≤0.98, 0.02≤c2≤0.3, 0.01≤d2≤0.12, 0<e2≤0.1, M² includes at least one of Al, Zr, B, Y, Sr, W, Ti, or Nb, and M² at least includes Al. The first particle was a single crystal particle, and the second particle was a polycrystalline particle.

### Comparative Example 1

This Comparative Example referred to Example 1 for the process, the difference lied in the first particle from Example1 was used as the positive electrode active material.

### Comparative Example 2

This Comparative Example referred to Example 1 for the process, the difference lied in the second particle from Example1 was used as the positive electrode active material.

### Comparative Example 3

This Comparative Example referred to Example 1 for the process, the difference lied in the first particle and the second particle, specifically as follows:

### Preparation of a First Particle

LiOH·H₂O, Ni(OH)₂, Co(OH)₂, Mn(OH)₂, and NaOH were uniformly mixed at a molar ratio of 1.5:0.88:0.06:0.06:0.5 (a total weight of Li, Ni, Co, and Mn was calculated as 0.67a), then Al(OH)₃, Y₂O₃, and ZrO₂ were added, where a weight of Al(OH)₃ was 0.24% a, a weight of Y₂O₃ was 0.14% a, and a weight of ZrO₂ was 0.36% a. After mixing, the mixture was added to a crucible, the crucible was placed in a box-type muffle furnace (at oxygen atmosphere with a gas flow rate of 20 ml/min), the temperature was heated up to 450° C. at a heating rate of 5° C./min and maintained for 12 h, then it was naturally cooled to room temperature. After crushing, 0.72% a of H₃BO₃ was added, the mixture was heated to 350° C. and maintained for 7 h. After crushing and sieving, a first particle was obtained, where Can was 800 ppm, C_{Zr1} was 2500 ppm, C_{B1} was 1200 ppm, D₁ was 3 μm, Dv¹₅₀ was 3.2 μm, CNi was 0.87, a thickness of a shell was 5.5 nm, and BET₁ was 1 m²/g.

### (2) Preparation of a Positive Electrode Plate

A positive electrode active material (the first particle and a second particle were mixed at a weight ratio of 85:15, where the second particle was commercially available, C_{Al2} was 4000 ppm, C_{Zr2} was 2500 ppm, D₂ was 300 nm, D₃ was 10 μm, Dv²₅₀ was 10.3 μm, C_{Ni2} was 0.85, and BET₂ was 0.6 m²/g), polyvinylidene fluoride, single-walled carbon nanotube, and multi-wall carbon nanotube were uniformly mixed at a weight ratio of 97.4:1.2:0.4:1, NMP was added to obtain a positive electrode slurry (with a solid content of 65%); the positive electrode slurry was uniformly applied onto an aluminum foil (with a thickness of 10 μm) using coating machine, after being baked at 120° C. for 12 h, followed by rolling to obtain a positive electrode plate, where a press density Q of the positive electrode plate was 3.38 g/cm³, and CAD/CAM was 5.

### Test Example

### Cycle Life Test

The batteries prepared from Examples and Comparative Examples were placed in a constant temperature environment of 45° C., and the charging and discharging test was carried out at a rate of 1.8 C/4.0 C, with a cut-off voltage ranging from 2.5 V to 4.3 V. The batteries were charged and discharged 300 cycles, and the cycling discharge capacity was recorded and divided by the discharge capacity of the first cycle to obtain the cycling capacity retention rate after 300^{th} cycle. The thickness data of every 100 cycles was recorded, a fully charged thickness data after the 300^{th} cycle was divided by a thickness in the initial state (50% SOC) of the battery to obtain the 300^{th} cycle thickness expansion rate, and the results of the cycling capacity retention rate after 300^{th} cycle and the thickness expansion rate after 300^{th} cycle were recorded in Table 1.

### (2) Furnace Temperature Test

The batteries prepared from Examples and Comparative Examples were placed in a 25° C. environment, charged to 4.3V at a constant current of 0.5 C, then charged at a constant voltage until a cut-off current was 0.025 C, and left standing for 2 h. The fully charged batteries were placed in a thermal box and heated from normal temperature to 130° C. at a heating rate of 5° C./min, then continued to heat at a heating rate of 1° C./min, held for 30 min every 1° C. If the batteries did not explode or catch fire, it continued to be heat; if the batteries exploded or caught fire, the highest temperature before the explosion or fire was recorded, and the results were recorded in Table 1.

### (3) C-Rate Test

The batteries prepared from Examples and Comparative Examples were placed at 25° C.
1) The batteries were left standing for 5 min.
2) The batteries were discharged to 2.5 V at a rate of 0.5 C.
3) The batteries were left standing for 1 hour.
4) The batteries were charged at a rate of 0.5 C, when a voltage of the battery terminal reached a charging limit voltage of 4.3 V, the batteries began to be charged at a constant voltage, The charging was not stopped until a charging current is less than or equal to a cut-off current.
5) The batteries were left standing for 30 min.
6) The batteries were discharged to 2.5V at a specific rate, the capacity, internal resistance, voltage, and other data during the process were recorded, and the specific rate was as follows: 1C and 4C. Steps 3) to 6) were performed repeatedly until the test rate ended. In step 6) the batteries was discharged according to the specified rate and sequence, and the capacity retention rate was recorded in Table 1.

### (4) Capacity Per Gram Test

The positive electrode active materials used in Examples and Comparative Examples, conductive carbon black SP, and polyvinylidene fluoride were mixed at a weight ratio of 94:3:3. The NMP was dispersed to form a slurry. The slurry was evenly applied on the surface of an aluminum foil sheet, and dried at 80° C. for 12 h to obtain a positive electrode plate. The positive electrode plate after drying was rolled and cut into a wafer. The wafer was placed in a glove box for standby use. A 2032-type button battery was assembled by using the above positive electrode plate as a positive electrode, using lithium metal as a negative electrode, using Celgard 2400 (microporous polypropylene film) as a separator, and using 1 mol/L of LiPF₆ mixed with ethylene carbonate, ethyl methyl carbonate, and dimethyl carbonate in a weight ratio of 1:1:1 as an electrolyte solution. The capacity per gram test was performed on the obtained button battery, and a first discharge capacity per gram of the positive electrode active material was calculated from a discharge capacity and a weight of the positive electrode active material, specifically as follows.
1. The button battery was left standing for 10 min.
2. Constant current and constant voltage charging: The button battery was fully charged at 0.1 C, a cut-off current was 0.025 C, and a cut-off voltage was 4.3 V.
3. The button battery was left standing for 10 min.
4. Constant current discharging: The button battery was discharged to 3.0V at 0.1 C.
5. Step 1 to step 4 were performed repeatedly twice and the results were recorded in Table 1.

TABLE 1

| | | | | C-rate Test | | |
|---|---|---|---|---|---|---|
| | | | | Capacity | Capacity | |
| | Cycle Life Test | | | Retention | Retention | |
| | Cycling | | | Rate | Rate | |
| | Capacity | Thickness | Furnace | at | at | Capacity |
| | Retention | Expansion | Temperature | 1 | 4 | per |
| | Rate | Rate | Test | C | C | gram |
| | (%) | (%) | (° C.) | (%) | (%) | (mAh/g) |
| Example 1 | 92.2 | 3.50 | 140 | 99.1 | 98.1 | 215.2 |
| Example 2 | 94.1 | 2.80 | 145 | 100.0 | 98.2 | 207 |
| Example 3 | 89.3 | 7.01 | 135 | 98.0 | 97.1 | 238 |
| Example 4a | 89.0 | 4.50 | 136 | 97.5 | 96.0 | 205 |
| Example 4b | 87.4 | 9.1 | 132 | 96.1 | 94.2 | 231 |
| Example 5a | 89.0 | 4.10 | 138 | 97.2 | 96.3 | 214 |
| Example 5b | 88.1 | 4.21 | 137 | 96.1 | 94.1 | 211.5 |
| Example 6a | 88.5 | 3.93 | 138 | 98.3 | 97.1 | 213.4 |
| Example 6b | 85.9 | 4.10 | 136 | 96.1 | 95.5 | 212.1 |
| Example 7a | 87.3 | 4.23 | 136 | 98.3 | 97.3 | 214.1 |
| Example 7b | 89.2 | 3.85 | 139 | 96.4 | 95.1 | 216 |
| Example 8a | 90.1 | 3.64 | 136 | 98.5 | 97.2 | 217.1 |
| Example 8b | 88.3 | 5.80 | 132 | 97.1 | 95.9 | 222.1 |
| Example 9 | 85.8 | 6.12 | 137 | 97.4 | 96.3 | 213.2 |
| Example 10a | 88.5 | 6.69 | 133 | 99.3 | 98.2 | 215.5 |
| Example 10b | 91.5 | 3.95 | 139 | 96.5 | 95.1 | 214.5 |
| Example 11a | 88.4 | 4.71 | 138 | 98.1 | 97.4 | 213.8 |
| Example 11b | 89.1 | 4.40 | 138 | 98.3 | 96.9 | 211.4 |
| Example 12a | 87.6 | 4.12 | 137 | 96.8 | 95.4 | 214.1 |
| Example 12b | 88.4 | 3.91 | 138 | 97.1 | 96.6 | 212.9 |
| Example 13a | 88.8 | 4.85 | 138 | 98.2 | 97.3 | 214.2 |
| Example 13b | 89.0 | 4.50 | 139 | 98.7 | 97.5 | 213.3 |
| Example 14a | 89.4 | 4.72 | 138 | 99.1 | 96.9 | 206.5 |
| Example 14b | 88.5 | 4.63 | 139 | 97.7 | 96.8 | 205.9 |
| Example 15a | 95.1 | 2.71 | 143 | 100.0 | 99.1 | 215.2 |
| Example 15b | 93.2 | 3.20 | 141 | 99.2 | 98.4 | 215.2 |
| Example 15c | 91.0 | 6.51 | 138 | 98.4 | 97.1 | 215.2 |
| Example 15d | 89.1 | 9.32 | 135 | 96.1 | 94.8 | 215.2 |
| Example 16 | 91.0 | 3.9 | 135 | 96.2 | 95.4 | 215.2 |
| Example 17 | 88.5 | 5.10 | 135 | 98.6 | 97.3 | 214.2 |
| Comparative | 89.9 | 4.70 | 137 | 95.8 | 94.0 | 214.5 |
| Example 1 | | | | | | |
| Comparative | 86.0 | 7.10 | 135 | 99.0 | 98.1 | 217.8 |
| Example 2 | | | | | | |
| Comparative | 84.5 | 7.20 | 130 | 97.0 | 96.0 | 214.3 |
| Example 3 | | | | | | |

As can be learned from Table 1, on the premise of the capacity per gram is close, the battery prepared with the positive electrode active material of the present disclosure can balance cycling performance, high-temperature performance, and furnace temperature safety performance compared to Comparative Examples. For example, compared to Comparative Example 1, the battery in Example 1 has a positive electrode active material composed of the first particle and the second particle, and the content of element Al in both meets a specific relationship, thus ensuring high capacity per gram while having good cycling performance, high-temperature performance, and furnace temperature safety performance.

The preferred examples of the present disclosure have been described in detail above, but the present disclosure is not limited thereto. Within the technical concept of the present disclosure, various simple modifications can be made to the technical solutions of the present disclosure, including combining various technical features in any other suitable manner. These simple modifications and combinations should also be regarded as the disclosed content of the present disclosure and fall within the protection scope of the present disclosure.

What is claimed is:

1. A positive electrode active material, comprising:
a first particle and a second particle; wherein,
the first particle comprises a substance with a chemical formula Liₐ₁Ni_{b1}Co_{c1}Mn_{d1}M¹ₑ₁O₂, wherein, 0.8≤a1≤ 1.3, 0.8≤b1≤0.98, 0.02≤c1≤0.2, 0.01≤d1≤0.14, 0<e1≤0.08, M¹ comprises at least one of Al, Zr, B, Y, Sr, W, Ti, Mg, or Nb, and M¹ comprises at least Al;
the first particle comprises a single crystal particle;
the second particle comprises a substance with a chemical formula Liₐ₂Ni_{b2}CO_{c2}Mn_{d2}M²ₑ₂O₂, wherein, 0.9≤a2≤1.3, 0.8≤b2≤0.98, 0.02≤c2≤0.3, 0.01≤d2≤0.12, 0<e2≤0.1, M² comprises at least one of Al, Zr, B, Y, Sr, W, Ti, Mg, or Nb, and M² comprises at least Al;
the second particle comprises a polycrystalline particle;
the first particle comprises element Al, and a weight content of element Al in the first particle is C_{Al1};
the second particle comprises element Al, and a weight content of element Al in the second particle is C_{Al2}; and
C_{Al1} and C_{Al2} satisfy 0.4≤C_{Al2}/C_{Al1}≤4.

2. The positive electrode active material according to claim 1, wherein, 0.5≤C_{Al2}/C_{Al1}≤3; and/or,
C_{A11} ranges from 500 ppm to 3000 ppm; and/or,
C_{Al2} ranges from 900 ppm to 3500 ppm; and/or,
based on a total weight of the positive electrode active material, a content of the first particle is C1, 70%≤C1<100%.

3. The positive electrode active material according to claim 2, wherein, 1.2≤C_{Al2}/C_{Al1}≤1.3; and/or,
C_{A11} ranges from 800 ppm to 2000 ppm; and/or,
C_{Al2} ranges from 1000 ppm to 2400 ppm; and/or,
73%≤C1≤93%.

4. The positive electrode active material according to claim 1, wherein, the first particle further comprises element Zr, and a weight content of element Zr in the first particle is C_{Zr1}; the second particle further comprises element Zr, and a weight content of element Zr in the second particle is C_{Zr2}, and C_{Zr1} and C_{Zr2} satisfy 2500 ppm≤C_{Zr1}+C_{Zr2}≤8000 ppm; and/or,
C_{Zr1} ranges from 1300 ppm to 3800 ppm; and/or,
C_{Zr2} ranges from 1000 ppm to 4500 ppm.

5. The positive electrode active material according to claim 4, wherein, 3000 ppm≤C_{Zr1}+C_{Zr2}≤6800 ppm; and/or,
C_{Zr1} ranges from 1600 ppm to 3200 ppm; and/or,
C_{Zr2} ranges from 1400 ppm to 3600 ppm.

6. The positive electrode active material according to claim 4, wherein, 4600 ppm≤C_{Zr1}+C_{Zr2}≤5200 ppm.

7. The positive electrode active material according to claim 1, wherein, the first particle further comprises element B, a weight content of element B in the first particle is C_{B1}, and C_{A11} and C_{B1} satisfy 1000 ppm≤C_{A11}+C_{B1}≤6000 ppm; and/or,
C_{B1} ranges from 100 ppm to 3000 ppm.

8. The positive electrode active material according to claim 7, wherein, 1100 ppm≤C_{A11}+C_{B1}≤3800 ppm; and/or,
C_{B1} ranges from 300 ppm to 1800 ppm.

9. The positive electrode active material according to claim 1, wherein, an average particle size of the first particle D₁ ranges from 0.5 μm to 4 μm; an average particle size of the second particle D₃ ranges from 6 μm to 18 μm; and D₁ and D₃ satisfy: 0.01≤D₁/D₃≤0.5; and/or,
the first particle is a layered structure material; and/or,
the second particle is a layered structure material.

10. The positive electrode active material according to claim 9, wherein, 0.07≤D₁/D₃≤0.3; and/or,
the first particle is the single crystal particle; and/or,
the second particle is the polycrystalline particle; and/or,
the average particle size of the second particle D₃ ranges from 7 μm to 15 μm; and/or,
the second particle is composed of several primary particles, and average particle sizes of the primary particles D₂ range from 100 nm to 900 nm.

11. The positive electrode active material according to claim 1, wherein, the first particle further comprises elements Ni, Co, and Mn, and based on a total molar number of elements Ni, Co, and Mn in the first particle, a molar number of element Ni is C_{Ni1}; the second particle further comprises elements Ni, Co, and Mn, and based on a total molar number of elements Ni, Co, and Mn in the second particle, a molar number of element Ni is C_{Ni2}, and C_{Ni1}≥ C_{Ni2}; and/or,
C_{Ni1} ranges from 0.81 to 0.95; and/or,
C_{Ni2} ranges from 0.8 to 0.94.

12. The positive electrode active material according to claim 1, wherein, the first particle comprises a core and a shell on the outer surface of the core, and the shell comprises at least one of elements Al, Zr, B, Ti, or Nb; and/or,
a thickness of the shell ranges from 3 nm to 25 nm.

13. The positive electrode active material according to claim 1, wherein, a specific surface area of the first particle is BET₁, a specific surface area of the second particle is BET₂, and BET₁ and BET₂ satisfy: 1.2≤BET₁/BET₂≤4; and/or,
0.7 m²/g≤BET₁≤1.6 m²/g; and/or,
0.3 m²/g≤BET₂≤1.1 m²/g.

14. A positive electrode plate, comprising the positive electrode active material according to claim 1.

15. The positive electrode plate according to claim 14, wherein, a press density of the positive electrode plate is Q, in unit of g/cm³, the first particle further comprises element B, a total weight content of element Al and element B in the first particle is C, in unit of ppm, and Q and C satisfy: 160≤C/Q≤1700.

16. The positive electrode plate according to claim 15, wherein, 300≤C/Q≤1100; and/or,
Q ranges from 3.3 to 3.6, in unit of g/cm³.

17. A battery, comprising the positive electrode active material according to claim 1.

18. The battery according to claim 17, further comprising a negative electrode plate, wherein the negative electrode plate comprises a negative electrode current collector and a negative electrode active material layer on at least one side surface of the negative electrode current collector, and the negative electrode active material layer comprises a silicon-based material; and
a weight content of the silicon-based material in the negative electrode active material layer ranges from 0.01% to 50%.

19. The battery according to claim 18, wherein, the weight content of the silicon-based material in the negative electrode active material layer ranges from 18% to 25%; and/or,
the silicon-based material comprises at least one of elemental silicon, silicon oxygen, silicon carbon, or silicon alloy.

20. The battery according to claim 17, further comprising a positive electrode plate, wherein, the positive electrode plate comprises the positive electrode active material; the battery further comprises a negative electrode plate and a separator, the positive electrode plate, the separator, and the negative electrode plate are wound;
the positive electrode plate comprises a positive tab, the negative electrode plate comprises a negative tab; and a total number of the positive tab and the negative tab is greater than or equal to 2.
